(19) United States
(12) Patent Application Publication
(10) Pub. No.: US 2008/0213437 A1
(43) Pub. Date: Sep. 4, 2008

(54) Lollipop and messaging system

(76) Inventor: Paul Leonhardt, La Jolla, CA (US)

Correspondence Address: GRIMES & BATTERSBY, LLP, 488 MAIN AVENUE, THIRD FLOOR, NORWALK, CT, 06851, US

(21) Appl. No.: 12/074,374

(22) Filed: Mar. 3, 2008

Related U.S. Application Data
(60) Provisional application No. 60/904,222, filed on Mar. 1, 2007.

(51) Int. Cl. A23G 3/56

(52) U.S. Cl. 426/132

(57) ABSTRACT

A messaging lollipop comprising a re-usable hollow handle comprises a hollow core into which a message of various forms such as printed material or an electronic medium may be received, extracted, stored or transported. Access to the hollow handle is provided by various means including those which motivate the consumption of the lollipop before access to the message is allowed.

### CROSS REFERENCES TO RELATED APPLICATIONS

This application claims priority benefit of a U.S. Provisional Application, Ser. No. 60/904,222, filed in the United States Patent and Trademark Office on Mar. 1, 2007, and entitled “Interactive Candy Device”.

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to a candy product for delivering content in a new and unique way, and more particularly to a lollipop having a hollow cylindrical handle within which a document, booklet or electronic message may be inserted, stored, transported, and or extracted.

Lollipops in their basic form have been well-known for at least several decades. The conventional basic form of a lollipop is a thin usually cylindrical cardboard stick that has a piece of hard candy attached to one end. In known lollipops, the candy may be substantially spherical, disk-like, or various other shapes. The candy is eaten by a person holding the stick to position the candy in the mouth for licking and/or biting. Once the candy has been consumed, the stick is discarded.

### SUMMARY OF THE INVENTION

A subject of the invention is a lollipop comprising a ball of hard candy and a preferably non-edible hollow stick handle. The handle has a first end extending into a cavity in the ball of candy and an opposite gripping end. The lollipop comprises pressed candy and a hollow handle for receiving, storing, transporting, and extracting a message in various media forms including either paper and or electronic files.

The hollow handle is designed in two configurations. In the first the message is accessible to a consumer without eating the candy first. In the second configuration, the candy must be consumed before the consumer can access or open the hollow handle. Thus the consumer can be strongly motivated to consume the candy immediately upon acquisition.

The advantages and features discussed above and other advantages and features will become apparent from the detailed description of the best mode for carrying out the invention that follows.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1A illustrates a cross-sectional view of a first embodiment of the present invention;

FIG. 1B illustrates a side view of the message roll;

FIG. 1C illustrates a side view of the of a first embodiment of the present invention;

FIG. 2A illustrates a side view of a second embodiment of the present invention in an closed configuration;

FIG. 2B illustrates a side view of a second embodiment of the present invention in an open configuration;

FIG. 2C illustrates a cross-sectional view of a second embodiment of the present invention in the open configuration;

FIG. 3A illustrates a side view of a third embodiment of the present invention in an open configuration;

FIG. 3B illustrates a side view of a third embodiment of the present invention in an closed configuration;

FIG. 4A illustrates a side view of a fourth embodiment of the present invention in an open configuration;

FIG. 4B illustrates a side view of a fourth embodiment of the present invention in an closed configuration;

FIG. 5A illustrates a side view of a fifth embodiment of the present invention in a disassembled configuration;

FIG. 5B illustrates a side view of a message assembly of a fifth embodiment of the present invention;

FIG. 6A illustrates a perspective view of a sixth embodiment of the present invention in an open configuration;

FIG. 6B illustrates a side view of a sixth embodiment of the present invention in an closed configuration; and

FIG. 6C illustrates a side view of a sixth embodiment of the present invention in an open configuration.

### DETAILED DESCRIPTION OF THE EMBODIMENT

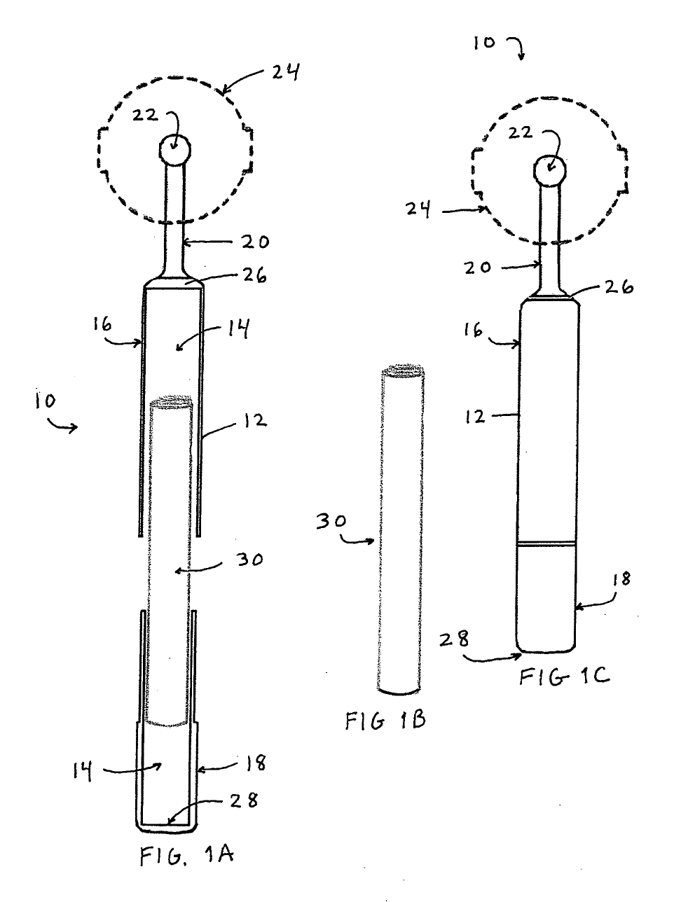

Detailed reference will now be made to the preferred embodiments of the present invention, examples of which are illustrated in the accompanying drawings. Referring to FIGS. 1A & 1C, the messaging lollipop 10 of the present invention comprises a candy product 24 and a handle 12 for such product, said handle 12 including a hollow core 14 which is comprised by an upper handle portion 16 and a lower handle portion 18. Extending away from the hollow core 14 on the upper handle 16 is a stem 20 terminating in a small ball 22 for mounting or affixing the candy product 24 to said ball 22. In the preferred embodiment, the handle 12 comprises a cylindrical lollipop handle 12 while the candy product 24 is a hard candy for the lollipop 10.

The stem 20 on the upper handle 16 is of solid manufacture and affixed to a roof 26 of the upper handle 16. The roof 26 seals the hollow core portion 14 of the upper handle 16 so as to prevent any candy or other outside agent from entering the hollow core 14. The lower handle 18 is similarly sealed by a floor 28. The entire hollow core 14 is sealed at the manufacturer by a joining of the upper handle 16 with the lower handle 18. Such seal is designed to protect the contents (described below) from damage or contamination.

The lower handle 18 is mated to the upper handle 16 by means of a friction or snap fit as is well known in the art. Other methods may be used such as a twist-off cap (not shown). In a twist-off cap embodiment, both the upper handle 20 and the lower handle 18 may include complementary thread elements (not shown) to allow for the screwing and unscrewing of the lower handle 18. It should be appreciated that other means for sealing the bottom of the hollow handle 18 are possible, including a plug or a one-time seal.

Referring now to FIGS. 1A & 1B a message roll 30 is shown. The content of a message, advertisement, comic strip or the like is printed on a suitable sheet of material, circularly rolled up into the message roll 30 and inserted within the hollow core 14 at manufacture. The preferred embodiment of the content comprises a comic book or joke page. Of course, any document that may be rolled up to fit inside the hollow core 14 may be inserted.

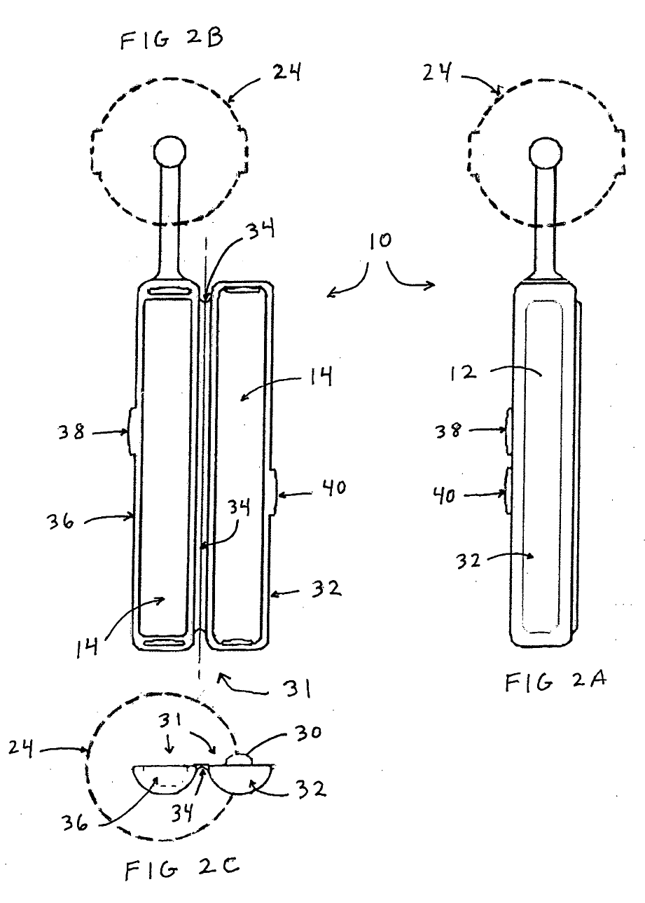

Referring now to FIGS. 2A through 2C a second embodiment of the messaging lollipop 10 is shown. In this embodiment the handle 12 is made of a split cylinder 31 comprising a door 32 attached to a frame portion 36 by means of a hinge 34. The door 32 rotates on said hinge 34 to snap open or closed. The open position is shown in FIGS. 2B & 2C and the closed position is shown in FIG. 2A. Two finger tabs 38 & 40 are respectively attached to each of the frame 36 and door 32 so as to facilitate opening by an opposing force such as one exerted by a user's thumb and forefinger. The message roll 30 as shown in FIG. 2C may be in either half of the handle upon opening.

The two cylinder halves, the door 32 and frame 36 being cylindrical in shape as shown in FIG. 2C comprise the hollow core 14 for receiving the message roll 30 at the time of manufacture. Of course the device is reusable and children and others may reuse the messaging lollipop 10 even after consumption of the candy 24 to save or exchange messages or other content among themselves. It should also be observed that in each of the above embodiments, the consumer can access the message without consumption of the candy 24, that is, both hollow cores 14 are accessible to the consumer regardless of whether the candy 24 has been consumed or not.

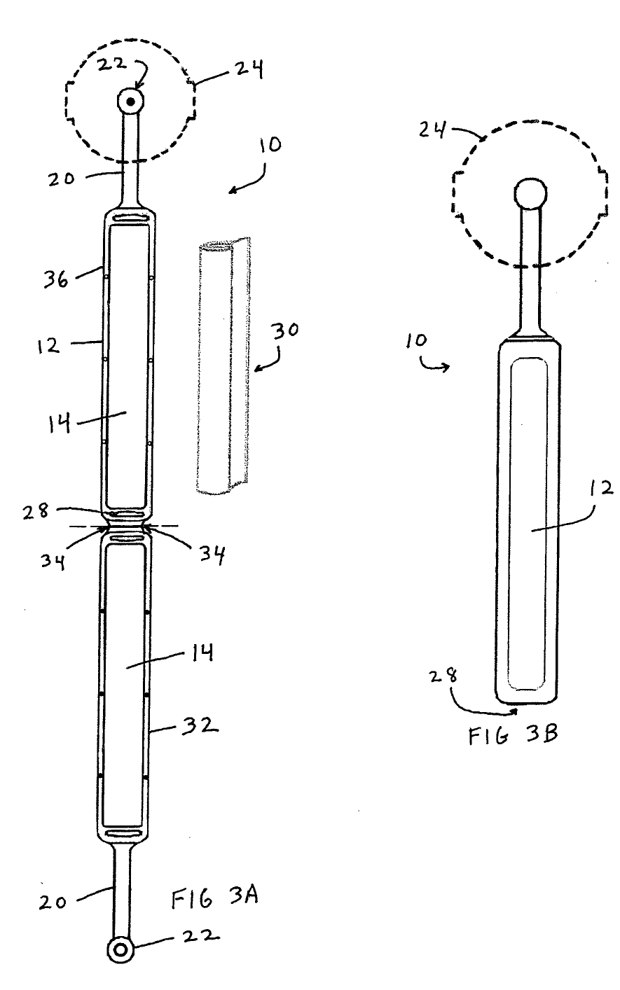

Referring now to FIGS. 3A & 3B a third embodiment of the message lollipop 10 is shown. In this embodiment the handle 12 is comprised of a split cylinder having a frame 36 and a door 32 attached by a hinge 34. The hinge 34 is positioned at the bottom of the handle 12 and forms part of the handle floor 28. In this embodiment the consumer cannot access the message roll 30 until the candy 24 is consumed because the stem 20 and ball 22 are part of each half of the split cylinder. As shown in FIG. 3A, one half of the stem 20 and ball 22 are attached to the door portion 32 of the handle 12. Thus the consumer is motivated to consume the candy 24 in order to gain access to the message roll 30.

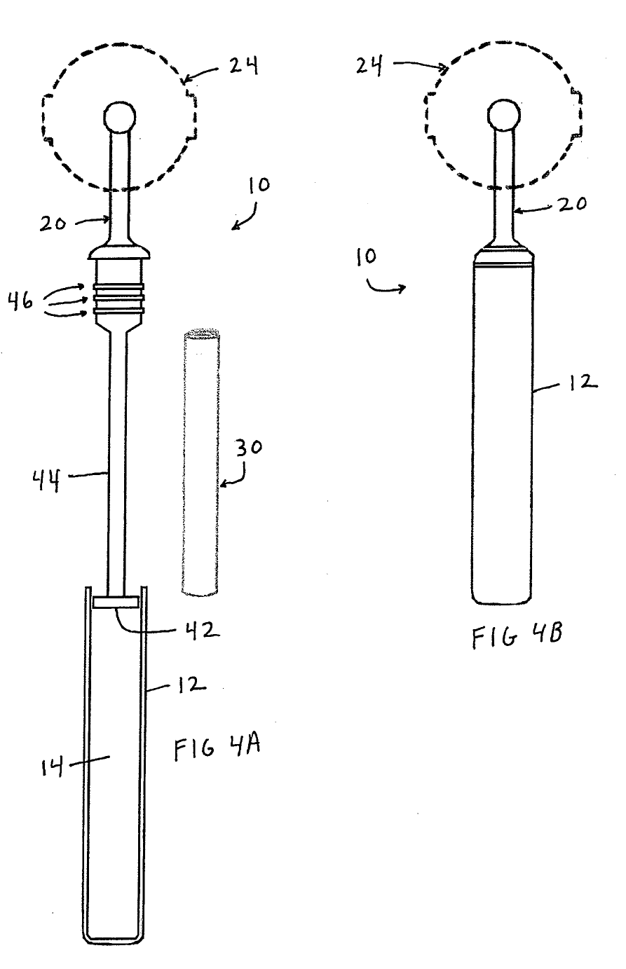

Referring now to FIGS. 4A & 4B another embodiment of the present invention is shown. In this embodiment the stem 20 is attached to a plunger 42 by a shaft 44. The plunger 42 is designed to frictionally fit inside the hollow core 14 of the handle 12. The message roll 30 is securely wrapped around the shaft 44 for storage and transport. Just below the stem 20 are several flexible seals 46 for sealing and mating with the inside of the handle 12 at manufacture or at a later time when reused by the consumer. In this embodiment, the message roll 30 is accessible to the consumer prior to the consumption of the candy 24. FIG. 4B shows the embodiment in the closed position whereby the shaft 44 and plunger 42 have been slide into the hollow core 14 of the handle 12 and the seals 46 have mated with the inside of the handle 12.

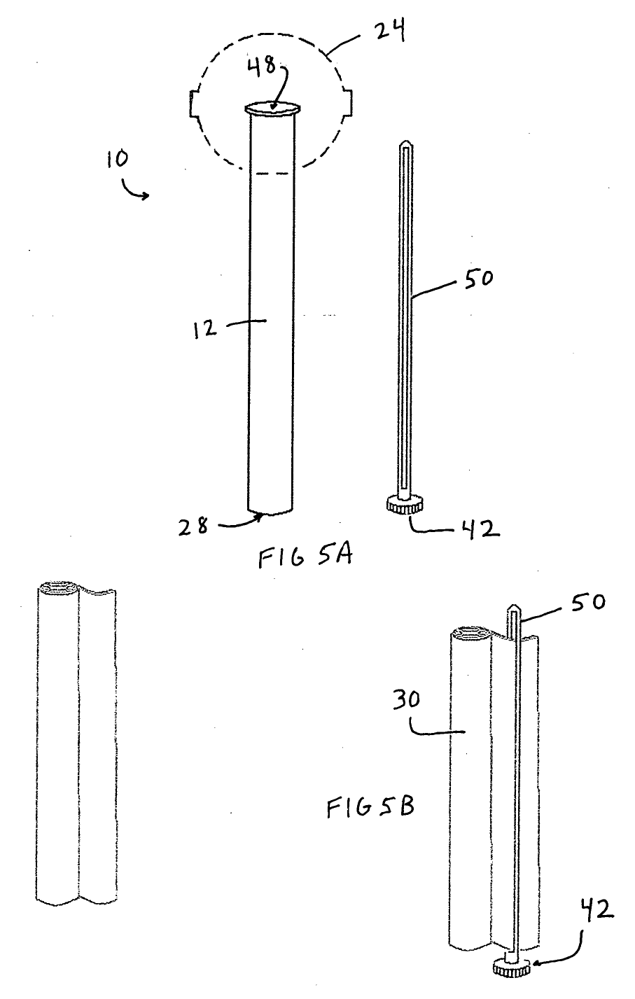

FIGS. 5A & 5B illustrate a further embodiment of the present invention. In this embodiment the handle 12 is comprised of a tube shape with a sealed floor 28 and an open top 48. The message roll 30 is wrapped around a suitably dimensioned spindle 50 for insertion into the tube handle 12 from the open top 48. The spindle 50 has a plunger 42 for inserting and retrieving the spindle 50 from the tube handle 12. At the time of manufacture the candy 24 is formed onto the handle 12 after the message roll 30 and spindle 50 have been inserted into the tube handle 12. Thus in this embodiment, the message roll 30 is not available to the consumer until after the candy 24 has been consumed and this configuration motivates the consumer to devour the candy to reach the message roll 30. A crease (not shown) may be set into any paper used for the message so as to anchor the paper into the spindle slot.

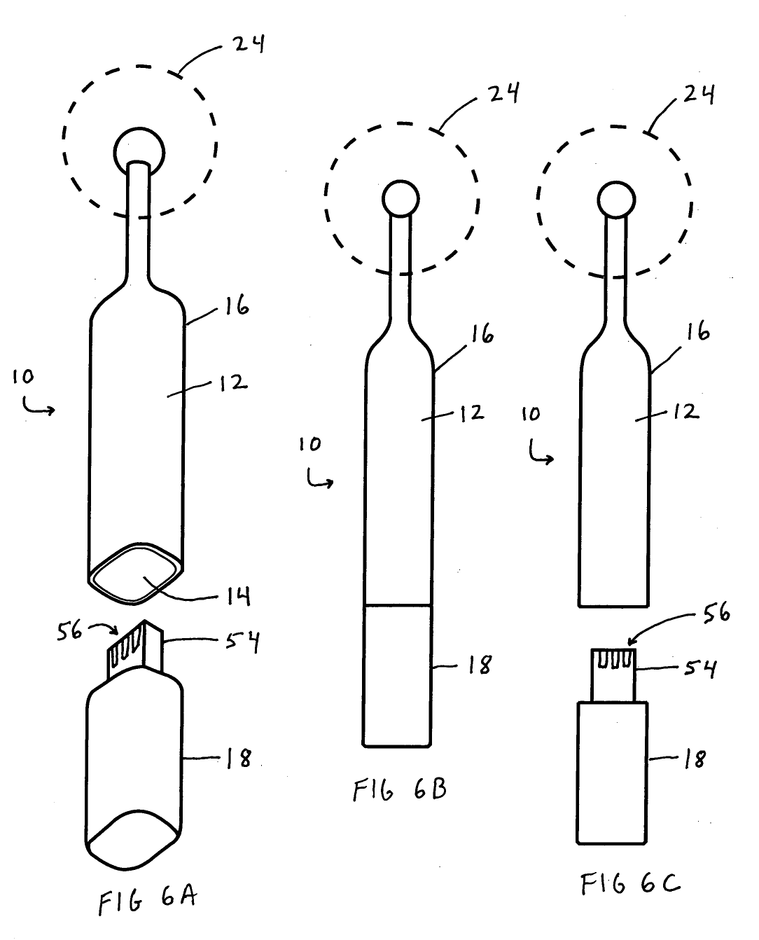

Referring now to FIGS. 6A-6C another embodiment of the present invention is shown. The message lollipop 10 has a handle 12 comprised by an upper handle 16 and a lower handle 18 which are frictionally or snap-fit mated for opening and closing the hollow core 14. The hollow core 14 is entirely comprised in the upper handle 16. The lower handle 18 further comprises a Universal Serial Bus (USB) memory stick, also known as a USB flash drive. The USB stick is pre-programmed prior to assembly with electronic content such as pictures, text, or programs for consumption by the user. Further the USB stick has electrical contacts 56 suitably designed to mate with a USB port on any common personal computer. The USB contacts 56 and supporting substrate are received into the hollow core 14 as the two handle portions are assembled. The consumer merely detaches the lower handle 18 and plugs the USB stick 54 into his personal computer to read, receive or make use of the message content. It should also be noted that the USB memory stick can be formed into a plug and inserted inside the tube handle 12 in FIG. 5A. In that configuration the USB stick would not be accessible to the consumer until the candy was removed. This configuration whereby the candy itself has formed a lock to the hollow cavity may be used to deliver any kind of message in any kind of media, such as paper, trinket, chain, necklace or electronic file in a USB memory stick.

It should be noted that any part of the handle 12, such as the upper portion 16 or the lower handle 18 may be fabricated from clear plastic. This would allow the consumer to see the shape and form of the message contents, before actually gaining access to such, in whatever form that maybe, such as printed or electronic, and such transparency of the handle 12 may further enhance the motivation and intrigue of the consumer to acquire and enjoy the product.

It should also be noted that the manufacture of the present invention must comply with certain governmental regulations as candy is a food product and the food product as well as any ancillary delivery portion thereof such as the stem 20, ball 22, handle 12, message roll 30 or USB stick 54 will have to comply with such regulations for direct food and oral contact with consumers.

It is also further envisioned that the handle portion may be made entirely of an edible material so that the entire lollipop excepting the message portion may be edibly consumed by a purchaser.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

I claim:

1. A messaging lollipop comprising
a candy portion;
a handle portion for securing said candy portion thereto, and
a sealable hollow cavity within said handle portion for storing a retrievable message.

2. A messaging lollipop as in claim 1 and in which said handle portion is divided into halves along a transverse axis and further includes:
a first half of said handle portion comprising a tubular shaped upper handle portion having a partially hollow interior; and
a second half of said handle portion comprising a similarly tubular shaped lower handle portion having a partially hollow interior; wherein said upper and lower handle portions are adapted to telescopically mate together and form said hollow cavity.

3. A messaging lollipop as in claim 1 and in which said handle portion is divided into halves along a longitudinal axis and further includes:
a first half of said handle portion comprising a handle frame portion having a partially hollow interior; and
a second half of said handle portion comprising a similarly shaped handle door portion having a partially hollow interior;
a flexible hinge joining a first longitudinal edge of said handle frame portion to another first longitudinal edge of said handle door portion
wherein said halves rotationally mate into a closed position forming said hollow cavity.

4. A messaging lollipop as in claim 1 in which said handle is manufactured from a transparent material.

5. A messaging lollipop as in claim 1 in which said handle is manufactured entirely from an edible material.

6. A messaging lollipop as in claim 1 in which said message is printed on paper or other malleable material and stored in said hollow cavity.

7. A messaging lollipop as in claim 1 and further comprising:
an electronic message retrievably stored in an electronic medium; and
whereby said electronic message is retrievably stored in said hollow cavity

8. A messaging lollipop as in claim 2, in which said first half of said handle portion has a first set of threads and said second half of said handle portion has a second set of threads;
wherein said upper and lower handle portions are adapted so that said pair of threads screw together and form said sealable hollow cavity.

9. A messaging lollipop as in claim 3 and further comprising:
a first tab on a second a second longitudinal edge of said handle frame portion; and
a second tab on a second longitudinal edge of said handle door portion;
whereby said tabs are forceably separated from each other when said handle is in a closed position to configure said handle into an open position revealing said message in said hollow cavity.

10. A messaging lollipop as in claim 6 in which said electronic message comprises a USB memory stick integral to an inner surface of said lower handle portion.

11. A messaging lollipop comprising
a candy portion;
a handle portion for securing said candy portion thereto,
a hollow cavity within said handle portion for storing a retrievable message; and
a candy lock;
whereby said retrievable message stored in said hollow cavity is unretrievable by a consumer until the candy lock is removed or devoured.

12. A messaging lollipop as in claim 11 and further comprising:
a stem and a ball extending from a proximal end of said handle portion for mounting said candy portion;
said handle portion including said stem and said ball, split into two halves along a longitudinal axial plane and said two halves hingedly connected at an end distal to said candy portion;
said halves rotatable about said hinge joint between an open position and a closed position; said halves forming said cavity when in said closed position;
whereby said handle is secured in said closed position by said candy portion formed on said split ball until said candy portion has been removed or consumed.

13. A messaging lollipop as in claim 11 and further in which:
said handle is tube shaped having a closed bottom and an open top;
a messaging plug for sealably inserting into said tube top opening;
said messaging plug securing a message inside said tube;
whereby said candy portion is formed over the handle top after the message plug has been inserted into said handle tube;
wherein said message is not accessible to said consumer until said candy lock is removed or devoured.

14. A messaging lollipop as in claim 11 in which said handle is manufactured from a transparent material.

15. A messaging lollipop as in claim 11 in which said handle is manufactured entirely from an edible material.

16. A messaging lollipop as in claim 11 in which said message is printed on paper or other malleable material and stored in said hollow cavity.

17. A messaging lollipop as in claim 11 and further comprising:
an electronic message retrievably stored in an electronic medium; and
whereby said electronic message is retrievably stored in said hollow cavity

18. A messaging lollipop as in claim 11 in which said message is trinket, chain, necklace or other toy-like item.

19. A messaging lollipop as in claim 13, in which said tube top has a first set of threads and said message plug has a second set of threads;
wherein said tube top and message plug are adapted so that said pair of threads screw together and form said sealable hollow cavity.

20. A messaging lollipop as in claim 17 in which said electronic message comprises a USB memory stick integral to an inner surface of said lower handle portion.
